(19) United States
(12) Patent Application Publication
(10) Pub. No.: US 2015/0326941 A1
(43) Pub. Date: Nov. 12, 2015

(54) SOFTWARE BASED WIRELESS CHANNEL-AWARE ADAPTIVE VIDEO BIT RATE ENCODING

(71) Applicants: Jie Gao, Sunnyvale, CA (US); Xintian Eddie Lin, Palo Alto, CA (US); Babu P. Lukose, Portland, OR (US); Noam Ginsburg, Haifa (IL); Ulun Karacaoglu, San Diego, CA (US)

(72) Inventors: Jie Gao, Sunnyvale, CA (US); Xintian Eddie Lin, Palo Alto, CA (US); Babu P. Lukose, Portland, OR (US); Noam Ginsburg, Haifa (IL); Ulun Karacaoglu, San Diego, CA (US)

(21) Appl. No.: 13/993,083

(22) PCT Filed: Sep. 30, 2011
(86) PCT No.: PCT/US11/54390

§ 371 Date: Apr. 7, 2015

(51) Int. Cl. H04N 21/6373; H04N 21/4402; H04N 21/442; H04N 21/4363

(52) U.S. Cl. CPC H04N 21/6373; H04N 21/43635; H04N 21/43637; H04N 21/4402; H04N 21/44227

(57) ABSTRACT

A data transmitting device predicts wireless channel conditions based on certain transmission parameters in which data packets are transmitted. The transmission parameters directly corresponding to wireless channel conditions. Based on the parameters, a video encoding bit rate at a video encoder of the transmitting device may be adjusted to support the wireless channel conditions.

### BACKGROUND

Wireless display (WiDi) technology is an example of a video technology that enables sharing content from a device such as a personal computer (PC). Content from the device may be transmitted over a wireless channel to a television (TV), another PC display/screen, or other WiDi enabled device. In certain implementations, a WiDi adapter may be used at the receiving end. Audio data may be transmitted separately from video data, since audio data is encoded at a much lower rate than video data.

At the transmitting device, display/screen or video data is sent to a video encoder. Packetized video data from the video encoder may then be wirelessly transmitted over an Institute of Electrical and Electronics Engineers (IEEE) 802.11 interface, or more commonly known as WiFi interface. Transmitted video data is received by a WiDi adapter or WiDi enabled device. The received video data is decoded and displayed to a video screen such as a high definition TV (HDTV).

Since encoded video data is transmitted over a wireless channel, the quality of the video depends on channel condition. WiDi devices may implement a fixed rate video encoding (e.g., bit rate of 8 Megabits per second “Mbps”). Therefore, if channel conditions become worse, for example due to interference or noise, and cannot support an existing encoding data rate through the wireless channel, video quality may deteriorate. Deterioration may due to losing packets or lengthy packet retransmission.

### BRIEF DESCRIPTION OF THE DRAWINGS

The detailed description is described with reference to accompanying figures. In the figures, the left-most digit(s) of a reference number identifies the figure in which the reference number first appears. The same numbers are used throughout the drawings to reference like features and components.

FIG. 1 is a diagram illustrating an example system implementing wireless channel aware adaptive video bit rate encoding.

FIG. 2 is a diagram illustrating an example device that implements wireless channel aware adaptive video bit rate encoding.

FIG. 3 is a diagram illustrating an example adapter/device that receives video data implementing wireless channel aware adaptive video bit rate encoding.

FIG. 4 is a diagram illustrating an example group of pictures (GOP) of video data that implement wireless channel aware adaptive video bit rate encoding.

FIG. 5 is a table illustrating an example values relating modulation and coding selection (MCS) versus actual throughput for wireless channel aware adaptive video bit rate encoding scheme.

FIG. 6 is a flow chart illustrating an example method for wireless channel aware adaptive video bit rate encoding.

### DETAILED DESCRIPTION

### Overview

A software based, hardware independent, implementation in a video transmitting device, provides an ability to predict wireless channel conditions based on certain WiFi transmission parameters in which video packets are transmitted. The transmission parameters directly corresponding to wireless channel conditions. Accordingly, based on the parameters, a video encoding bit rate at a video encoder of the transmitting device may be adjusted to support the wireless channel conditions.

In the following detailed description, numerous specific details are set forth in order to provide a thorough understanding of the invention. However, it will be understood by those of ordinary skill in the art that the present invention may be practiced without these specific details. In other instances, well-known methods, procedures, components and circuits have not been described in detail so as not to obscure the present invention.

Some portions of the detailed description, which follow, are presented in terms of algorithms and symbolic representations of operations on data bits or binary digital signals within a computer memory. These algorithmic descriptions and representations may be the techniques used by those skilled in the data processing arts to convey the substance of their work to others skilled in the art.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, or transmission devices. The terms “a” or “an”, as used herein, are defined as one, or more than one. The term plurality, as used herein, is defined as two, or more than two. The term another, as used herein, is defined as, at least a second or more. The terms including and/or having, as used herein, are defined as, but not limited to, comprising. The term coupled as used herein, is defined as operably connected in any desired form for example, mechanically, electronically, digitally, directly, by software, by hardware and the like.

Some embodiments may be used in conjunction with various devices and systems, for example, a video device, an audio device, an audio-video (A/V) device, a Set-Top-Box (STB), a Blu-ray disc (BD) player, a BD recorder, a Digital Video Disc (DVD) player, a High Definition (HD) DVD player, a DVD recorder, a HD DVD recorder, a Personal Video Recorder (PVR), a broadcast HD receiver, a video source, an audio source, a video sink, an audio sink, a stereo tuner, a broadcast radio receiver, a display, a flat panel display, a Personal Media Player (PMP), a digital video camera (DVC), a digital audio player, a speaker, an audio receiver, an audio amplifier, a data source, a data sink, a Digital Still camera (DSC), a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless AP, a wired or wireless router, a wired or wireless modem, a wired or wireless network, a wireless area network, a Wireless Video Are Network (WVAN), a Local Area Network (LAN), a WLAN, a PAN, a WPAN, devices and/or networks operating in accordance with existing WirelessHD™ and/or Wireless-Gigabit-Alliance (WGA) specifications and/or future versions and/or derivatives thereof, devices and/or networks operating in accordance with existing IEEE 802.11 (IEEE 802.11-2007: Wireless LAN Medium Access Control (MAC) and Physical Layer (PHY) Specifications) standards and amendments, 802.11ad (“the IEEE 802.11 standards”). IEEE 802.16 standards, and/or future versions and/or derivatives thereof, units and/or devices which are part of the above networks, one way and/or two-way radio communication systems, cellular radio-telephone communication systems, Wireless-Display (WiDi) device, a cellular telephone, a wireless telephone, a Personal Communication Systems (PCS) device, a PDA device which incorporates a wireless communication device, a mobile or portable Global Positioning System (GPS) device, a device which incorporates a GiPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, a Wireless Application Protocol (WAP) device, or the like.

Some embodiments may be used in conjunction with one or more types of wireless communication signals and/or systems, for example. Radio Frequency (RF), Wi-Fi, Wi-Max, Ultra-Wideband (UWB), or the like. Other embodiments may be used in various other devices, systems and/or networks.

Some embodiments may be used in conjunction with suitable limited-range or short-range wireless communication networks, for example, “piconets”. e.g., a wireless area network, a WVAN, a WPAN, and the like.

### Example System

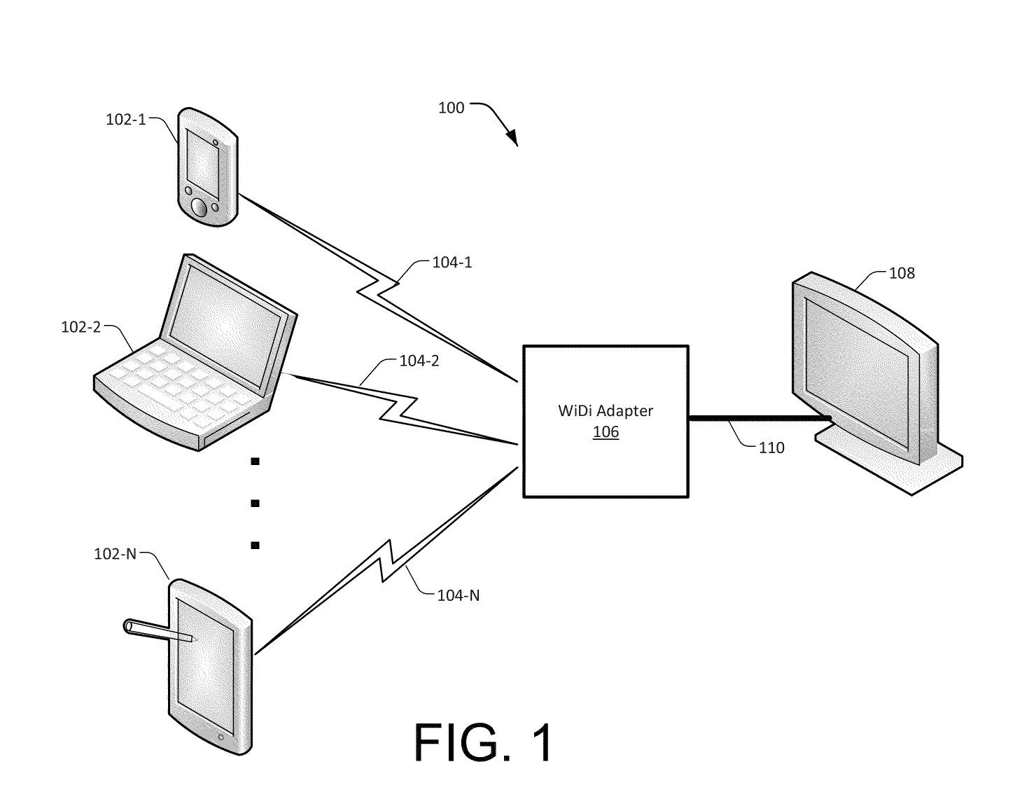

FIG. 1 shows a system-level overview of an example system environment 100 for implementing wireless channel aware adaptive video bit rate encoding from devices 102. Devices 102 include various devices, such as laptop computers, tablet computers, smart phones, etc. Furthermore, as discussed above, is to be understood that devices 102 may include other devices.

Devices 102 include a software based implementation to predict wireless channel conditions based on certain WiFi transmission parameters in which video packets are transmitted. Devices 102 are configured to encode and transmit audio and video data; however, in this discussion video data is addressed. In particular, encoded video data are packetized and transmitted over one or more wireless channels 104. In certain cases, wireless devices 102 contend to use the same wireless channel 104. Based on transmission parameters gathered at the devices 102, encoding rate of the video data is adjusted. Since the parameters are directly related to quality of the wireless channels 104, the encoding rate is adjusted based on the quality of the wireless channels.

In this example, a WiDi technology adapter 106 receives encoded and packetized video data from the devices 102 through the one or more wireless channels 104. A display device 108, such as an HDTV may be connected to the WiDi technology adapter 106, by a connection 110, such as a high definition multimedia input (HDMI) connection. In other implementations, WiDi technology enabled devices, such as HDTV units or other display devices, may directly incorporate WiDi technology.

### Example Device

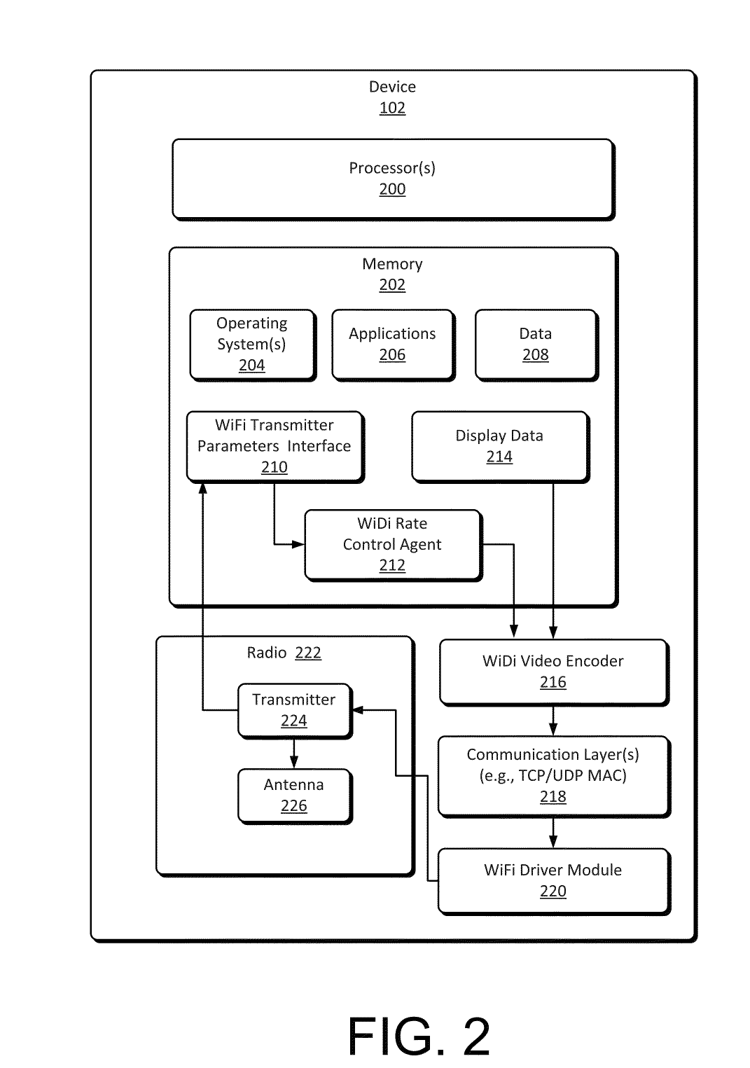

FIG. 2 is an example device 102 that implements wireless channel aware adaptive video bit rate encoding. Device 102 includes one or more processors, processor(s) 200. Processor(s) 200 may be a single processing unit or a number of processing units, all of which may include single or multiple computing units or multiple cores. The processor(s) 200 may be implemented as one or more microprocessors, microcomputers, microcontrollers, digital signal processors, central processing units, state machines, logic circuitries, and/or any devices that manipulate signals based on operational instructions. Among other capabilities, the processor(s) 200 may be configured to fetch and execute computer-readable instructions or processor-accessible instructions stored in a memory 202 or other computer-readable storage media.

Memory 202 is an example of computer-readable storage media for storing instructions which are executed by the processor(s) 200 to perform the various functions described herein. For example, memory 202 may generally include both volatile memory and non-volatile memory (e.g., RAM, ROM, or the like). Memory 202 may be referred to as memory or computer-readable storage media herein. Memory 202 is capable of storing computer-readable, processor-executable program instructions as computer program code that may be executed by the processor(s) 200 as a particular machine configured for carrying out the operations and functions described in the implementations herein.

Memory 202 may include one or more operating systems 204, and may store one or more applications 206. The operating system(s) 204 may be one of various known and future operating systems implemented for personal computers, audio video devices, etc. The applications 206 may include preconfigured/installed and downloadable applications. In addition, memory 202 can include data 208. Memory 202 includes a WiFi transmitter parameters interface 210 that gathers parameters related to video encoding rate and wireless channel conditions. The WiFi transmitter parameters interface 210 communicates with and provides the parameters to a WiDi rate control agent 212. Display data 214 is video data that is sent to WiDi video encoder 216. In certain implementations display data 214 may be included in data 208.

The WiDi video encoder 216 is configured to encode and packetize video or display data 214 based on WiDi defined technology. In certain implementations, for different video quality/resolution, such 720p and 1080p, different dynamic ranges for the video encoder may be provided. For example, for 720p resolution, the minimum and maximum video encoder rates may be 2 Mbps and 12 Mbps. For 1080p resolution, the minimum and maximum video encoder rates may be 3 Mbps and 20 Mbps.

Encoded and packetized video data may be sent to one or more communication layer(s) 218, where additional information may be added. A WiFi driver module 220 may receive the video data from the communication layer(s) 218. The WiFi driver module 220 may be configured to a radio 222. In particular, the WiFi driver module 220 may be configured to a transmitter 224 of the radio 222. The transmitter 224 is coupled to an antenna 226. It is to be understood that device 102 may include other communication interfaces (not shown), other than the radio 222.

Embodiments provide for software implementations. For example, the WiFi transmitter parameters interface 210 and WiDi rate control agent 212 may be implemented as software applications resident in memory 202. Therefore, hardware implementation may be avoided, such as modification of the radio 222. In certain implementations, the WiDi rate control agent 212. WiFi transmitter parameters interface 210, and video encoder 216 are resident in the same platform.

The WiFi transmitter parameters interface 210 may gather WiFi parameters that correlate to wireless channel condition or robustness. Such parameters may include WiFi transmission modulation and coding selection (MCS) rate. WiFi queue length. WiFi throughput, etc. The WiFi transmitter parameters interface 210 may gather such parameters through the transmitter 224. Based on these parameters, the encoding rate at the WiDi video encoder 216 is changed.

Modulation and codling selection or MCS rate may be a transmission rate as defined by a standard, such as IEEE 802.11. For example, for a IEEE 802.11g (i.e., WiFi) defined radio, MCS rate can vary from 6 Mbps to 54 Mbps. MCS rate is inherent to the transmitter 224, and may be acquired by the WiFi transmitter parameters interface 210. In certain implementations, the WiFi driver module 220 provides the MCS rate to the transmitter 224.

The MCS rate may vary depending on various conditions, such as proximity of transmitting device (e.g., device 102) to a receiving device (e.g., WiDi adapter 106). Therefore, when proximity is relatively close, signal strength is relatively strong, because of the high signal to noise ratio in the wireless channel. Conversely, when proximity is relatively far, strength is relatively weak, because of the low signal to noise ratio in the wireless channel. It follows that if MCS rate is determined to be low (i.e., near 6 Mbps), then wireless channel condition is relatively poor. If MCS rate is determined to be high (i.e., near 54 Mbps), then wireless channel condition is relatively good.

WiFi queue length is another parameter that may indicate robustness of the wireless channel, and may be acquired by the WiFi transmitter parameters interface 210. The WiFi driver module 220 may gather encoded and packetized video data for transmission, and queue up the video data for transmission. The queue at the WiFi driver module 220 may build up based on various conditions, including contention of other devices for a wireless channel for access to a receiving device. Therefore, WiFi queue length can indicate the availability of the bandwidth of the wireless channel. WiFi queue length may be expressed as a number of packets that are waiting in the WiFi driver module 220. In other words, the WiFi queue length is the total number of packets sent to the WiFi driver module 220, that have not been released.

Actual WiFi throughput is another parameter that may indicate robustness of the wireless channel, and may be acquired by the WiFi transmitter parameters interface 210. As discussed above, encoded and packetized video data may be sent to one or more communication layer(s) 218, where additional information may be added. The layers may include transmission control protocol (TCP)/user datagram protocol (UDP) and media access control (MAC) layers where additional information (e.g., headers and data) are added. Therefore, throughput at the application layer (i.e., before the communication layer(s) 218) may be higher than the actual throughput after the video data is processed by the communication layer(s). Therefore, the WiDi video encoder 216 may be limited based on actual throughput.

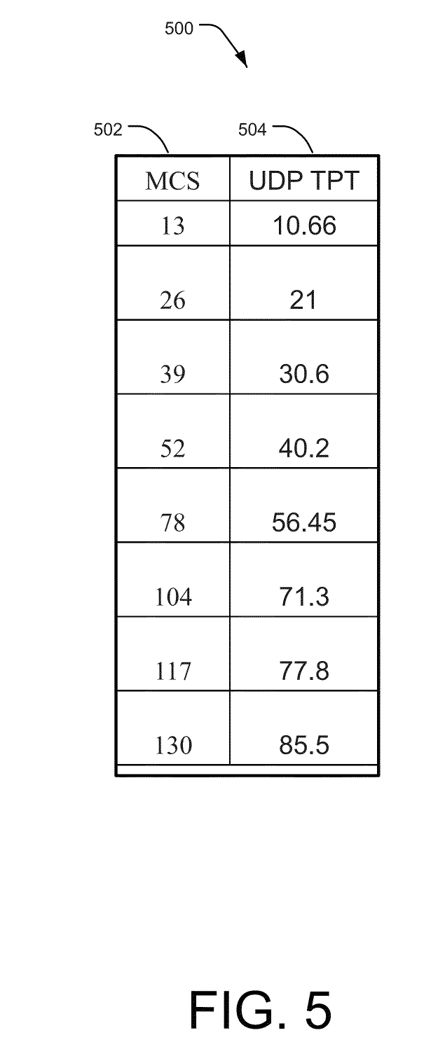

One method of determining actual throughput is to map MCS rate with expected throughput. The MCS rate may be acquired, and based on the mapping with expected throughput, an approximation of the actual throughput may be calculated. Such a table with an example mapping is discussed below in reference to FIG. 5.

Channel latency is another parameter that may be used to indicate robustness of the wireless channel. A determination may be made as to actual or expected throughput as described above. Each transmitted packet may be 1,500 bytes, or 12,000 bits (1500*8 bits/byte). To arrive at channel latency, channel, the value 12,000 bits is multiplied by WiFi queue length, divided by expected actual throughput.

The example device 102 described herein is merely an example that is suitable for some implementations and is not intended to suggest any limitation as to the scope of use or functionality of the environments, architectures and frameworks that may implement the processes, components and features described herein.

Generally, any of the functions described with reference to the figures can be implemented using software, hardware (e.g., fixed logic circuitry) or a combination of these implementations. Program code may be stored in one or more computer-readable memory devices or other computer-readable storage devices. Thus, the processes and components described herein may be implemented by a computer program product.

As mentioned above, computer storage media includes volatile and non-volatile, removable and non-removable media implemented in any method or technology for storage of information, such as computer readable instructions, data structures, program modules, or other data. Computer storage media includes, but is not limited to, RAM. ROM. EEPROM, flash memory or other memory technology. CD-ROM, digital versatile disks (DVD) or other optical storage, magnetic cassettes, magnetic tape, magnetic disk storage or other magnetic storage devices, or any other medium that can be used to store information for access by a computing device.

### Example WiDi Adapter/WiDi Enabled Device

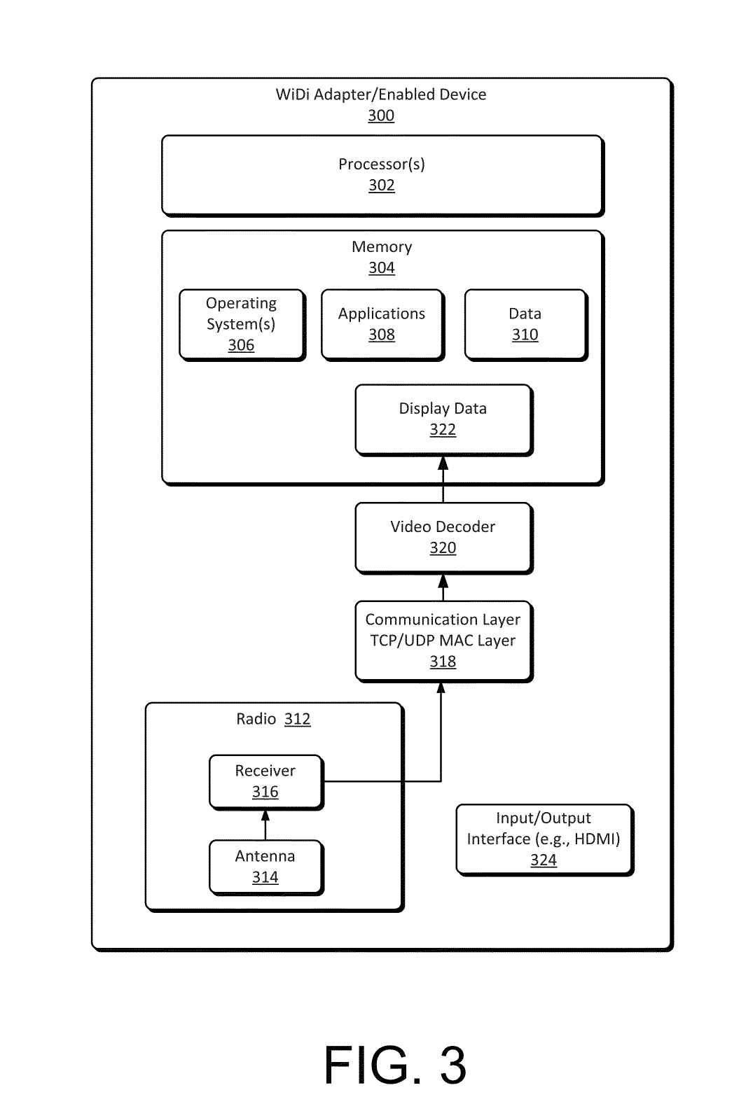

FIG. 3 is an example WiDi adapter or WiDi enabled device 300 that receives video data implementing wireless channel aware adaptive video bit rate encoding. Adapter/device 300 includes one or more processors, processor(s) 302. Processor(s) 302 may be a single processing unit or a number of processing units, all of which may include single or multiple computing units or multiple cores. The processor(s) 302 may be implemented as one or more microprocessors, microcomputers, microcontrollers, digital signal processors, central processing units, state machines, logic circuitries, and/or any devices that manipulate signals based on operational instructions. Among other capabilities, the processor(s) 302 may be configured to fetch and execute computer-readable instructions or processor-accessible instructions stored in a memory 304 or other computer-readable storage media.

Memory 304 is an example of computer-readable storage media for storing instructions which are executed by the processor(s) 302 to perform the various functions described herein. For example, memory 304 may generally include both volatile memory and non-volatile memory (e.g., RAM, ROM, or the like). Memory 304 may be referred to as memory or computer-readable storage media herein. Memory 304 is capable of storing computer-readable, processor-executable program instructions as computer program code that may be executed by the processor(s) 302 as a particular machine configured for carrying out the operations and functions described in the implementations herein.

Memory 304 may include one or more operating systems 306, and may store one or more applications 308. The operating system(s) 306 may be one of various known and future operating systems implemented for personal computers, audio video devices, etc. The applications 308 may include preconfigured/installed and downloadable applications. In addition, memory 304 can include data 310.

Adapter/device 300 includes a radio 222. The radio 222 includes one or more antenna 314 coupled to a receiver 316. Encoded and packetized video data sent from devices 102, implementing wireless channel aware adaptive video bit rate encoding, are received by the receiver 316. The received video data may be passed on through various communication layers 318. A video decoder 320 processes (decodes) the video data, and passes the video data to display data 322. The display data is processed and may be sent to a display device, such as a screen, via input/output interface 324. Input/output interface 324 may include a high definition multimedia input (HDMI).

The example device 300 described herein is merely an example that is suitable for some implementations and is not intended to suggest any limitation as to the scope of use or functionality of the environments, architectures and frameworks that may implement the processes, components and features described herein.

Generally, any of the functions described with reference to the figures can be implemented using software, hardware (e.g., fixed logic circuitry) or a combination of these implementations. Program code may be stored in one or more computer-readable memory devices or other computer-readable storage devices. Thus, the processes and components described herein may be implemented by a computer program product.

As mentioned above, computer storage media includes volatile and non-volatile, removable and non-removable media implemented in any method or technology for storage of information, such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium that can be used to store information for access by a computing device.

### Example Group of Pictures

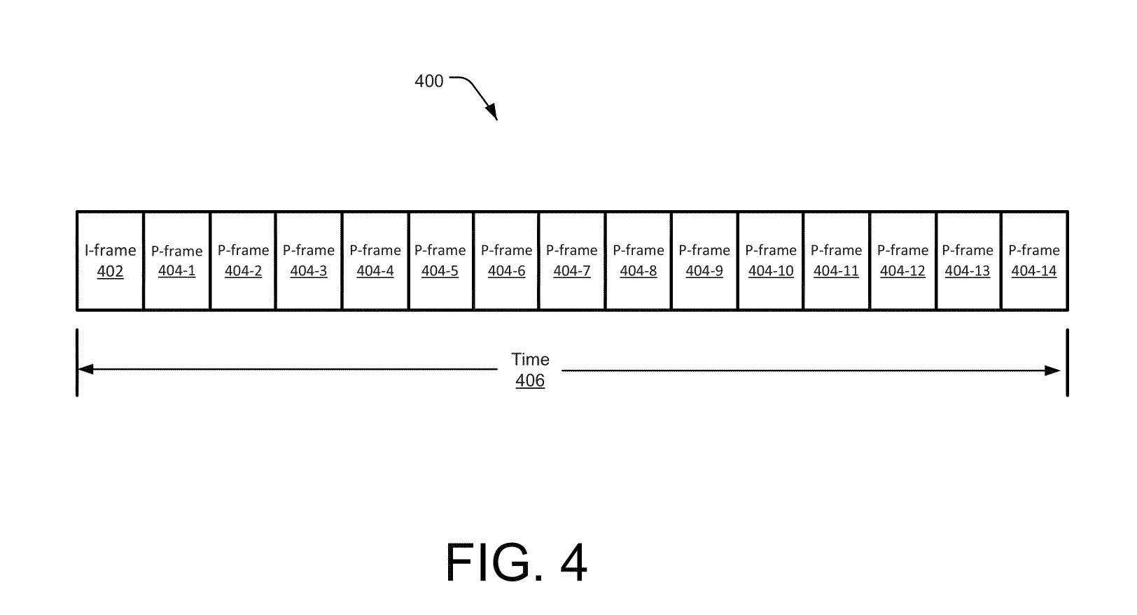

FIG. 4 shows an example group of pictures (GOP) 400 of video data. GOPs may be processed by the WiDi video encoder 216 as described above. The GOP 400 includes 15 frames, including one “I-frame” 402, and 14 “P-frames” 404. The GOP lasts 500 milliseconds (ms) (equivalent to 0.5 second) represented by time 406. Therefore, each of the frames 402 and 404 lasts 33 ms. In order to avoid disrupting video encoder operation, the newly suggested video encoder rates based on the acquired Wi-Fi parameters, are taken at the end of a GOP 400.

The WiFi parameters are sent to the WiDi rate control agent 212 to decide the action (e.g., decrease, increase, or stay) of the encoding rate at the WiDi video encoder 216 for a subsequent GOP. In particular, the WiDi video encoder 216 can compress less and use a higher encoding rate (e.g., 20 Mbps) when channel condition is good. Conversely, the WiDi video encoder 216 can compress more and use a lower encoding rate (e.g., 3 Mbps) when channel condition is bad.

### Example Mapping of MCS to Expected Actual Throughput

FIG. 5 is a table 500 that maps example values relating modulation and coding selection (MCS) to expected actual throughput for a wireless channel aware adaptive video bit rate encoding scheme. Column 502 lists example MCS rate values. As discussed above, MCS rate is inherent to WiFi transmission, and can be acquired during transmission of WiFi enabled data. Column 504 lists expected throughput. The values of column 504 may be derived from observation.

Because of added overhead, such as processing through various communication layers (i.e., communication layers 228), expected throughput is lower than MCS rate. Based on expected throughput an approximation of the actual throughput may be calculated.

### Example Process

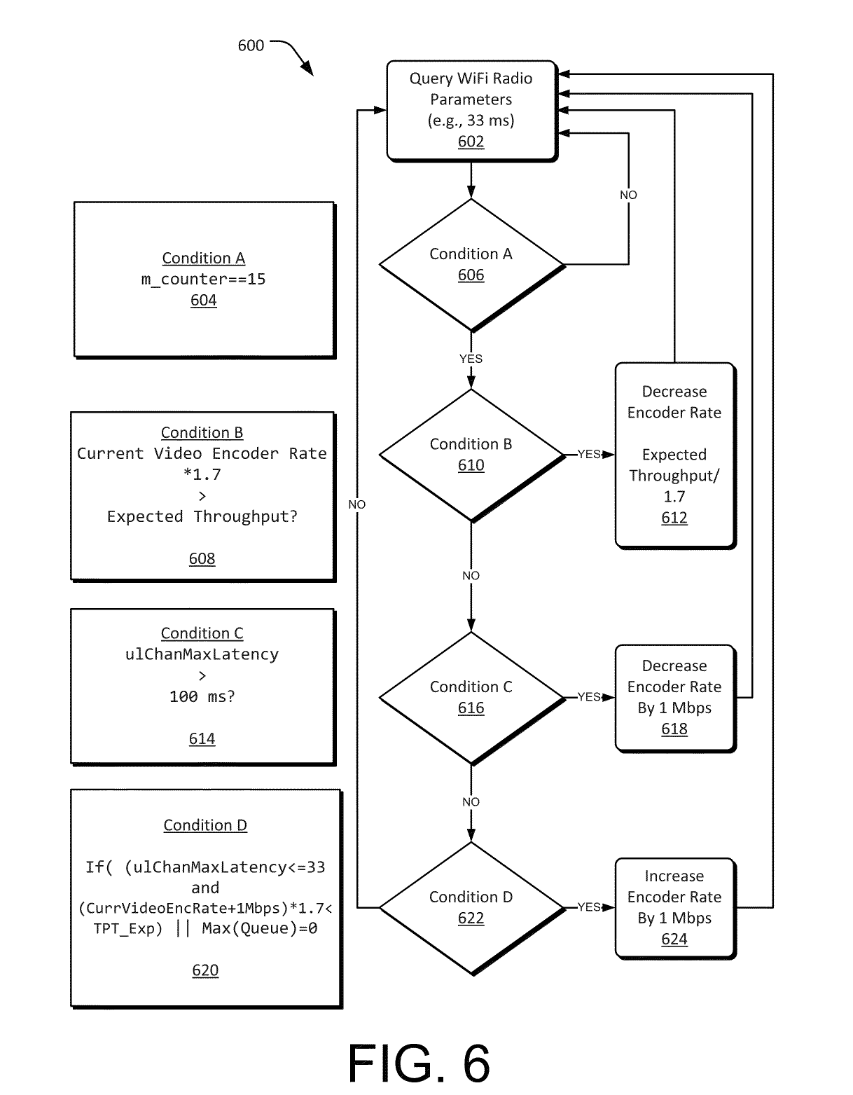

FIG. 6 shows an example process 600 for wireless channel aware adaptive video bit rate encoding. The order in which the method is described is not intended to be construed as a limitation, and any number of the described method blocks can be combined in any order to implement the method, or alternate method. Additionally, individual blocks may be deleted from the method without departing from the spirit and scope of the subject matter described herein. Furthermore, the method may be implemented in any suitable hardware, software, firmware, or a combination thereof, without departing from the scope of the invention.

At block 602, collecting WiFi radio parameters is performed. The collecting is performed for each frame of a GOP. Since each frame is approximately 33 ms, the collecting may be performed every 33 ns. The values of the parameters are temporarily stored.

A counter for each frame may be implemented, such that after 15 frames, the next GOP is processed. Condition A 604 represents a determination as to whether the counter is at 15 frames, such that next GOP may be processed. Therefore, following the “NO” branch of block 606, each frame is queried as to WiFi radio parameters, until the last frame of the GOP. The minimum parameters values are gathered. In other words, the lowest values of the parameters derived from all the frames is implemented in the remaining steps. For example, a minimum MCS rate may be obtain from all the frames.

After the end of the GOP, following the “YES” branch of block 606, condition B 608 is determined. Video encoders have certain efficiencies. In other words, a video encoder, such as WiDi video encoder 216, may have an efficiency that is greater than actual operation. In this example, a factor of 1.7 indicates that the video encoder has 70% greater efficiency. The “efficiency” factor 1.7 is multiplied with a current video encoder rate, and it is determined if that value is greater than expected throughput. If condition B proves to be true, following the “YES” branch of block 610, at block 612 the encoder rate is decrease to the value of expected value divided by efficiency factor (e.g. 1.7).

If condition B 608 is not true, then following the “NO” branch of block 612, condition C 614 is determined. A value is determined as to minimal effect upon user experience or degradation as to received data (e.g., no lost packets). The value in this example is 100 ms. Condition C 614 determines if the channel latency (as described above) is greater than determined value, 100 ms in this example. If condition C 614 is determined to be true, following the “YES” branch of block 616, at block 618 the encoder rate is decreased by 1 Mbps. The value 1 Mbps is determined based on minimal effect to user experience, as value 100 ms described above.

If condition C 614 is not true, the following the “NO” branch of block 616, condition D 620 is determined. Conditional D 620 determines if channel latency is less than 33 ms (i.e., time of a GOP frame) and if the value of the current encoder rate multiplied by the efficiency factor (e.g., 1.7) is less than the expected throughput, while the current frame queue (i.e., WiFi queue length) is at zero. If condition D 620 is determined to be true, following the “YES” branch of block 622, at block 624 current encoder bit rate is increased by 1 Mbps. The value 1 Mbps is determined based on minimal effect to user experience. If condition D is not true, following the “NO” branch of branch of block 622, encoder rate stays the same and process 600 goes back to block 602.

Realizations in accordance with the present invention have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the various configurations may be implemented as a combined structure or component. These and other variations, modifications, additions, and improvements may fall within the scope of the invention as defined in the claims that follow.

What is claimed is:

1. A method of changing video encoding rate comprising:
determining one or more parameters based on transmission of video data;
correlating the one or more parameters to condition of a wireless channel that the video data is transmitted over; and adjusting the video encoding rate based on the condition of the wireless channel.

2. The method of claim 1, wherein the determining includes acquiring a modulation and coding selection (MCS) rate.

3. The method of claim 1, wherein the determining includes calculating actual throughput of encoded video data.

4. The method of claim 1, wherein the determining includes mapping a modulation and coding selection (MCS) rate to an expected throughput of encoded video data.

5. The method of claim 1, wherein the determining includes calculating channel latency.

6. The method of claim 1, wherein the determining includes calculating packet queue length of data waiting to be transmitted.

7. The method of claim 1, wherein the correlating includes calculating the one or more parameters based on a modulation and coding selection (MCS) rate.

8. The method of claim 1, wherein the adjusting the video encoding rate includes a predefined minimum and maximum encoder rate.

9. The method of claim 1, wherein the adjusting the video encoding rate accounts for degradation of transmitted video data.

10. A device comprising:
one or more processors;
memory configured to the one or more processors that comprises:
an interface to receive transmission parameters based on transmission of video data over a wireless channel; and
a rate control agent that processes the transmission parameters; and
a video encoder that is adjusted by the rate control agent based on the transmission parameters.

11. The device of claim 10, wherein the interface receives transmission parameters from a transmitter of the device.

12. The device of claim 10, wherein the interface receives a queue length value from a driver module of the device.

13. The device of claim 10, wherein the interface receives one or more of the following transmission parameters: modulation and coding selection (MCS) rate, queue length, and/or encoded video throughput.

14. The device of claim 10, wherein the rate control agent accounts for video resolution and provides a minimum and maximum encoding rate based on the video resolution.

15. The device of claim 10, wherein the rate control agent processes a group of pictures (GOP) that includes multiple frames, parameters for each of the frames are determined, and the video encoder is adjusted only after all the frames of the GOP are determined.

16. A computer-readable storage medium having computer-readable instructions thereon which, when executed by a computing device, implement a method comprising
determining one or more parameters based on transmission of video data;
determining wireless channel conditions based on the one or more parameters;
adjusting an encoding rate of video data transmitted over the wireless channel based on the determined wireless channel conditions.

17. The computer-readable storage medium of claim 16 wherein the determining one or more parameters is based on processing each frame of a group of pictures (GOP).

18. The computer-readable storage medium of claim 16 wherein the determining one or more parameters gathers a modulation and coding selection (MCS) rate.

19. The computer-readable storage medium of claim 16 wherein the determining wireless channel conditions based includes gathering a modulation and coding selection (MCS) rate parameters and calculating other parameters based on the MCS rate.

20. The computer-readable storage medium of claim 16 wherein the adjusting accounts for video degradation that affects user experience.
